(19) United States
(12) Patent Application Publication
(10) Pub. No.: US 2022/0230112 A1
(43) Pub. Date: Jul. 21, 2022

(54) METHODS AND SYSTEMS FOR WORKFLOW AUTOMATION

(71) Applicant: INTUIT INC., Mountain View, CA (US)

(72) Inventors: Siben Nayak, Bangalore (IN); Govinda Sambamurthy, Bangalore (IN); Anil Sharma, Bangalore (IN); Srivatsan Vijayaraghavan, Bangalore (IN); Nishant Sehgal, Bangalore (IN); Suraj Menon, Bangalore (IN); Shyamalendu Tripathy, Bangalore (IN); Jatin Mahajan, Bangalore (IN); Nivedita Nayak, Bangalore (IN); Sachin Gupta, Bangalore (IN)

(73) Assignee: INTUIT INC., Mountain View, CA (US)

(21) Appl. No.: 17/153,918

(22) Filed: Jan. 21, 2021

(51) Int. Cl. G06Q 10/06

(52) U.S. Cl. CPC G06Q 10/06316; G06Q 10/06393; G06Q 10/067

(57) ABSTRACT

A workflow automation system that automates business tasks by executing task workflow models. The workflow automation system distributes actions to multiple clients based on roles and permissions to facilitate completion of manual and automated tasks included in the workflow models. The workflow automation system may pre-configure the roles and permissions to reduce the set up time for workflow model implementations of tasks. The workflow automation system improves the speed and efficiency of completing tasks relative to manual methods and other workflow automation tools.

### BACKGROUND

Business process management (BPM) workflows are standardized processes for generating documents, making decisions, and performing other business tasks. BPM workflows keep business operations running efficiently and in compliance with legal regulations and industry standards. Each workflow requires specific roles and permissions for each team member required to complete tasks included in the workflow. Creating, executing, and managing the specific roles and permissions is challenging in a digital environment. Therefore, configuring and executing current workflows for invoice creation, invoice approval, and other tasks is highly manual and time consuming. Existing tools for automating transaction workflows are highly complex and include many configurable parameters that must be set up to automate even simple task workflows. The complexity of these tools requires businesses to have one or more specialists dedicated to configuring and managing the automation tool. To improve the speed and efficiency of adopting and executing BPM workflows, it is desirable to develop a workflow automation solution that simplifies configuration of BPM workflows.

### BRIEF DESCRIPTION OF THE FIGURES

FIG. 1 is a flow diagram illustrating an example process of executing a transaction workflow according to various embodiments of the present disclosure.

FIG. 2 shows an example system configured to execute a transaction workflow according to various embodiments of the present disclosure.

FIG. 3 shows more details of the example system of FIG. 2 according to various embodiments of the present disclosure.

FIG. 4 shows more details of the example system of FIG. 3 according to various embodiments of the present disclosure.

FIG. 5 is a block diagram illustrating an example computing device according to an embodiment of the present disclosure.

### DETAILED DESCRIPTION OF SEVERAL EMBODIMENTS

Automating business tasks using current workflow automation tools is complex and time consuming. Current workflow automation tools include many parameters that must be manually configured for each business process management (BPM) workflow. Additionally, existing workflow automation tools are stand-alone applications; therefore, data required to implement each BPM workflow must be retrieved from other applications, further increasing the set up time and undermining the efficiency gains achieved through automation. This is undesirable.

Embodiments of the disclosure provide a workflow automation system that includes a library of task specific pre-configured BPM workflow model templates. The components (e.g., actions, triggers, and conditions) of the workflow model templates are pre-determined and automatically configured by the workflow automation system to streamline the set up process. For example, the roles and permissions of users assigned tasks in the BPM workflow are automatically generated by the workflow automation system.

Additionally, the workflow automation system interfaces with multiple in-product and remote applications. The workflow automation system allows users to complete automated workflow tasks in the in-product applications (i.e., the accounting and sales software currently used to complete tasks manually) to minimize the amount of time and effort required to transition from a manual workflow to an automated workflow. The workflow automation system also connects to remote applications to automatically migrate data required to implement and execute BPM workflows. For example, the workflow automation system may distribute notifications using contact information automatically retrieved from a remote application.

The embodiments of the disclosed workflow automation system improve the efficiency and speed of implementing BPM workflows. The workflow automation system also facilitates adoption of automated workflows by integrating BPM workflows into a wide variety of existing in-product applications. As a result, more tasks may be automated using BPM workflows, potentially resulting in higher employee productivity and lower operating costs.

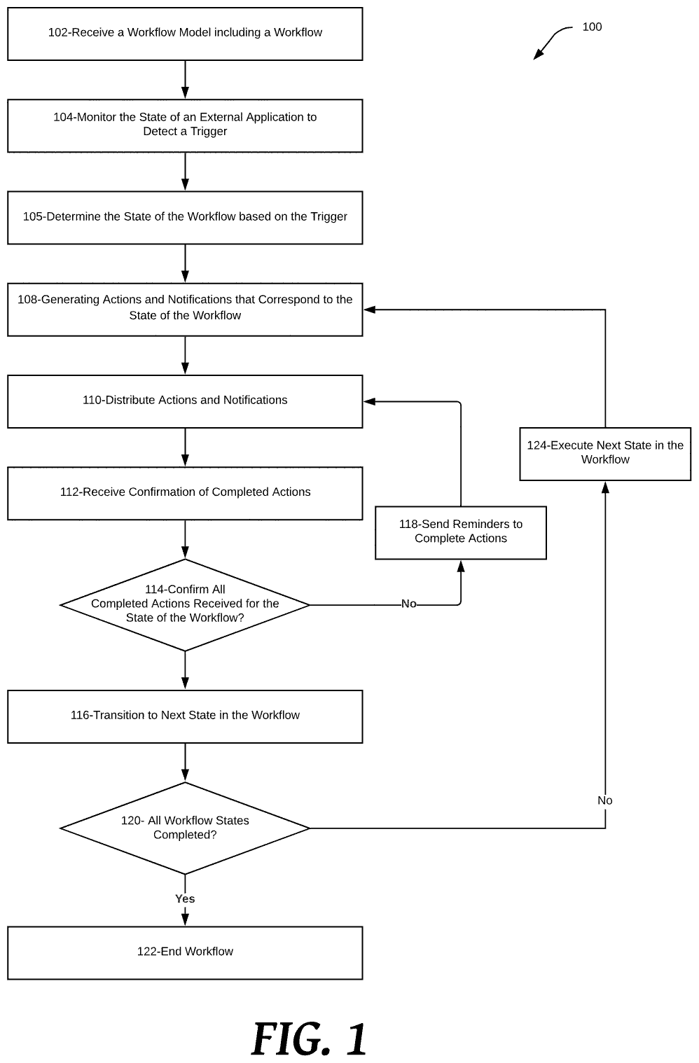

FIG. 1 is a block diagram illustrating an example process 100 for executing a task workflow using the disclosed workflow automation system. The task workflow digitally manages and executes a process for completing a business task (e.g., a BPM workflow for generating a document, approving a document, deciding on a course of action, approving a decision, and the like). At step 102, the workflow automation system loads a workflow model from a data store included in the workflow automation system. The workflow model includes a specific set of actions, conditions, and triggers that are used to complete a business task. The workflow model may include a plurality of states. Each state corresponds to a particular step in the process of completing a particular task. The plurality of states are arranged to systematically progress the task from start to completion.

Each state includes one or more actions, triggers, and conditions. The actions include specific subtasks that are to be completed during each state. For example, the actions included in a workflow model for generating an invoice may include monitoring an external application to detect a sales event, extracting data associated with the new sales event (e.g., customer id, transaction amount, transaction date, customer contract information, and the like) from the external application, populating the extracted data into an invoice document, distributing the invoice document to one or more employees for review, receiving approval of the invoice, distributing the invoice to the customer, and booking the amount of the invoice as an accounts receivable entry. The triggers describe particular events that must occur for the workflow to begin and or for the workflow to transition from one state to another. For example, the triggers of the invoice creation workflow model may include the creation of a new sales event in an external application that triggers the start of the first state of the invoice creation workflow model. Other triggers included in the invoice creation workflow model may include the extraction and population of sales event data into an invoice that triggers the transition between the invoice creation state and the invoice approval state of the invoice creation workflow. The conditions may include one or more characteristics that must be present for the workflow automation system to load a particular workflow model. The conditions may include one or more characteristics of an event or other trigger. For example, a condition for the invoice approval workflow may require the invoice amount to be above a certain amount threshold in order to initiate the invoice approval workflow.

The task workflow models also include configuration data. Configuration data includes a set of parameters that adapt task workflow models to fit specific business processes. Configuration data also includes a set of parameters that integrate task workflow models with applications, computer systems, and other tools used to complete the tasks that are automated by the task workflow models. Configuration data includes roles and permissions of employees and other users that need to complete one or more actions included in the task workflow model, notifications settings, security settings, application integrations for interfacing with other applications, and the like. To streamline the set up and implementation of new task workflow models, the configuration data includes pre-set parameters for each type of task workflow model. For example, the configuration data includes unique pre-set parameters for task workflows that perform particular tasks (e.g., generate documents, make decisions, approve documents and or decisions, and the like) and or are used by particular business units (e.g., accounting, sales, business development, legal, and the like).

At step 104, the workflow automation system monitors the state of an external application to detect a trigger for a particular workflow model. For example, a workflow monitoring service may monitor one or more in-product applications (i.e., applications that are within the same software product as the workflow automation system) and or external applications to detect a particular trigger. The external applications need not be integrated within the workflow automation system and may include cloud databases, file management systems, and other data storage applications; customer relationship management applications; e-commerce applications, billing applications, banking applications, accounting applications and other applications that track financial transactions; word processing applications and other document generating platforms; email applications, messaging platforms, calendar applications, and other business communications applications; and the like. The workflow automation system may detect the occurrence of a particular event in one or more of the applications as a trigger to initialize a particular task workflow model. For example, the creation of new business contact in a customer relationship management application may be detected as a trigger that initializes a workflow model for creating a project estimate or bid document for a particular type of product or service. The sale of a product through an e-commerce application may be detected as a trigger that initializes a workflow model for creating an invoice and or receipt. The occurrence of other events may be detected as triggers that transition the workflow model from one state to another state. For example, the completion of an invoice document in a word processing application may be detected as a trigger that transitions the invoice creation workflow model from a document creation state to a document approval state. The delivery of an approval confirmation in a business communications platform may be detected as a trigger that transitions the invoice creation workflow model from a document approval state to a document delivery state.

At step 106, the workflow automation system determines the state of the workflow based on the detected trigger. For example, the workflow automation system may determine that the workflow model is in the first state of the workflow based on detecting triggers that initialize a workflow model. The workflow automation system may determine the workflow model is in the second state based on detecting triggers that transition a workflow model from a first state to a second state. Each state included in the workflow model includes multiple pre-defined actions and or notifications. At step 108, the workflow automation system generates the actions and or notifications that correspond to the workflow state determined based on the detected trigger. The actions include particular subtasks that need to be completed automatically by one or more computer systems and or manually by one or more employees or other users. The notifications deliver the actions to the corresponding computer system and or employee required to complete each action.

At step 110, the actions and or notifications are distributed to remote computer devices. For example, notifications (e.g., emails, instant messages, text messages, and the like) including approval actions for one or more documents and or decisions may be distributed to multiple devices (e.g., computers, smartphones, and the like) associated with the employees or other users that are required to approve the documents and or decisions. Notifications including data extraction subtasks, document generation subtasks, and other automated actions may be distributed to multiple servers or other computer systems that have the access permissions, tools, and data required to complete the automated actions. Identification information (e.g., username, employee id, account name, device id, device endpoint, IP address, MAC address) for the users and or computer system receiving the notifications may be stored in the configuration data for each workflow model.

The identification information, roles, and permissions of each user and or computer system required to complete an action included in a workflow state of the workflow model are pre-configured to streamline the creation and execution of new task workflows by the workflow automation system. In one or more embodiments, the identification information and roles and permissions for the users and computer systems assigned the actions included in the workflow model are automatically determined based on the roles and permissions of user and or computer systems in one or more in-product applications and or remote applications. For example, the email addresses, administrator or user permissions, assigned tasks, and other configuration data for each user of an accounting platform that is integrated with the workflow automation system, may be used to automatically set up a workflow model that automates accounting tasks (e.g., invoice creation, invoice approvals, and the like). The workflow automation system may extract the configuration data for each of the relevant users from their user profiles in the accounting platform or other in-product or remote application. The workflow automation system may also automatically set-up the configuration data for a new workflow model based on the roles, permissions, and identification information of users and or computer systems involved in other workflow models.

At step 112, the workflow automation system receives confirmation of actions completed by users and or computer systems. The confirmation documenting the completed action may be a notification pushed to the workflow automation system from a user portal or other user interface (UI) component that receives inputs from employers and or other users. The confirmation may also be an API call, return message, or other communication sent from the computer system completing an automated action to the workflow automation system. At step 114, the workflow automation system determines if confirmations of completed actions have been received for all actions included in a particular state of the workflow model. If the workflow automation system does not receive confirmation of completed actions for all actions in the particular state of the workflow model, the workflow automation system may determine the actions that are not completed based on the received confirmations. At step 118, the workflow automation system sends reminders to complete actions to the users and or computer systems that have not provided confirmations of completed actions for each assigned action in the workflow state.

If confirmations of completed actions are received for all actions in a particular state of the workflow model, the workflow automation system transitions the workflow model to the next state in the workflow at step 116. For example, the workflow automation system may update the state of the workflow model to a new state that corresponds to the next step required to complete the task of the workflow model. At step 120, the workflow automation system determines if the new state corresponds to a finished workflow state indicating all states in the workflow model have been completed. For example, the workflow automation system may identify the finished workflow state based on configuration data for the workflow model listing the number of states in the workflow model or identifying the final action required to complete the task of the workflow. The workflow automation system may also identify the finished workout state upon determining that there are no actions in the state or detecting an end workflow trigger (e.g., a completed document in a particular storage location, a confirmation message approving a particular decision, and the like). In response to determining that the new workflow state is a finished workflow state (i.e., a yes at step 120), the workflow automation system ends the workflow at step 122.

If the workflow automation system determines that the new workflow state is not a finished workflow state (i.e., a no at step 120), the workflow automation system will execute the new state of the workflow at step 124. To execute the new state, the workflow automation system repeats steps 108-120. For example, the workflow automation system generates the actions and or notifications included in the new workflow state, distributes the actions and or notifications to users and computer systems, receives confirmations that the actions are completed, and transitions to a new state in the workflow. Steps 108-120 are repeated until each state in the workflow model is complete and all of the subtasks required to complete the task of the workflow model are finished and the task is done.

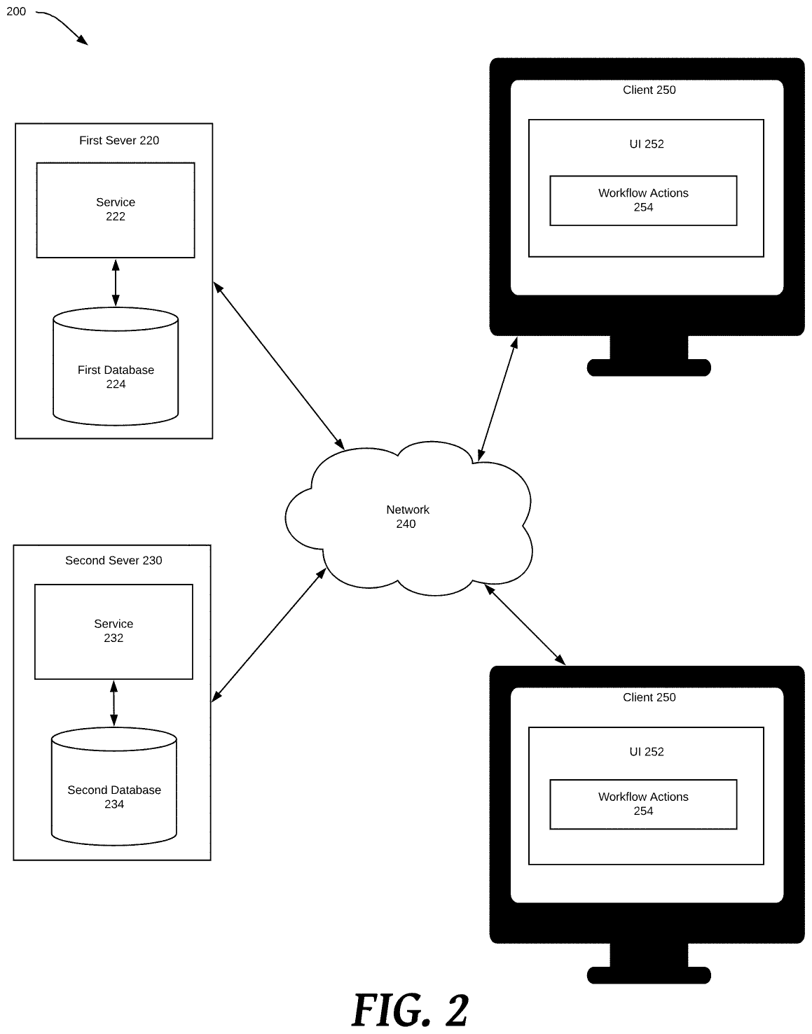

FIG. 2 shows an example system 200 configured to implement a process for task workflow automation according to an embodiment of the present disclosure. System 200 may include a first server 220, second server 230, and or one or more client devices 250. First server 220, second server 230, and or client device(s) 250 may be configured to communicate with one another through network 240. For example, communication between the elements may be facilitated by one or more application programming interfaces (APIs). APIs of system 200 may be proprietary and/or may be examples available to those of ordinary skill in the art such as Amazon® Web Services (AWS) APIs or the like. Network 240 may be the Internet and/or other public or private networks or combinations thereof.

First server 220 may be configured to implement a first service 222, which in one embodiment may be used to execute a workflow model to complete a business task. The first service 222 may input the workflow model based on a trigger via network 240 from one or more databases 224, 234, the second server 230 and or client device(s) 250. The first server 220 may execute the workflow model by generating multiple workflow actions 254 and or notifications that correspond to the workflow model's state according to the disclosed workflow automation principles stored in database 224, database 234, and or received from second server 230 and/or client device(s) 250. First service 222 or second service 232 may implement an event bus, which may monitor one or more applications to detect a trigger included in a state of the workflow model. For example, the event bus may detect a trigger of the first state of the workflow model that initializes the workflow model. The event bus may monitor events and data generated within any network 240 accessible application used to perform business functions (e.g., customer relations management, document generation, accounting, banking, e-commerce, employee communications, and the like). The event bus may also determine all states of the workflow model are complete and confirm the task of the workflow model is done based on events and or data generated within one or more applications. Other triggers detected by the event bus and or workflow automation system may transition the workflow model to a new state.

Client device(s) 250 may be any device configured to present user interfaces (UIs) 252 and receive inputs thereto. The UIs 252 may be configured to receive notifications and receive inputs thereto to review and complete workflow actions 254. Exemplary client devices 250 may include a personal computer, laptop computer, tablet, smartphone, or other device.

First server 220, second server 230, first database 224, second database 234, and client device(s) 250 are each depicted as single devices for ease of illustration, but those of ordinary skill in the art will appreciate that first server 220, second server 230, first database 224, second database 234, and or client device(s) 250 may be embodied in different forms for different implementations. For example, any or each of the first server 220 and second server 230 may include a plurality of servers or one or more of the first database 224 and second database 234. Alternatively, the operations performed by any or each of first server 220 and second server 230 may be performed on fewer (e.g., one or two) servers. In another example, a plurality of client devices 250 may communicate with first server 220 and/or second server 230. A single user may have multiple client devices 250, and/or there may be multiple users each having their own client device(s) 250.

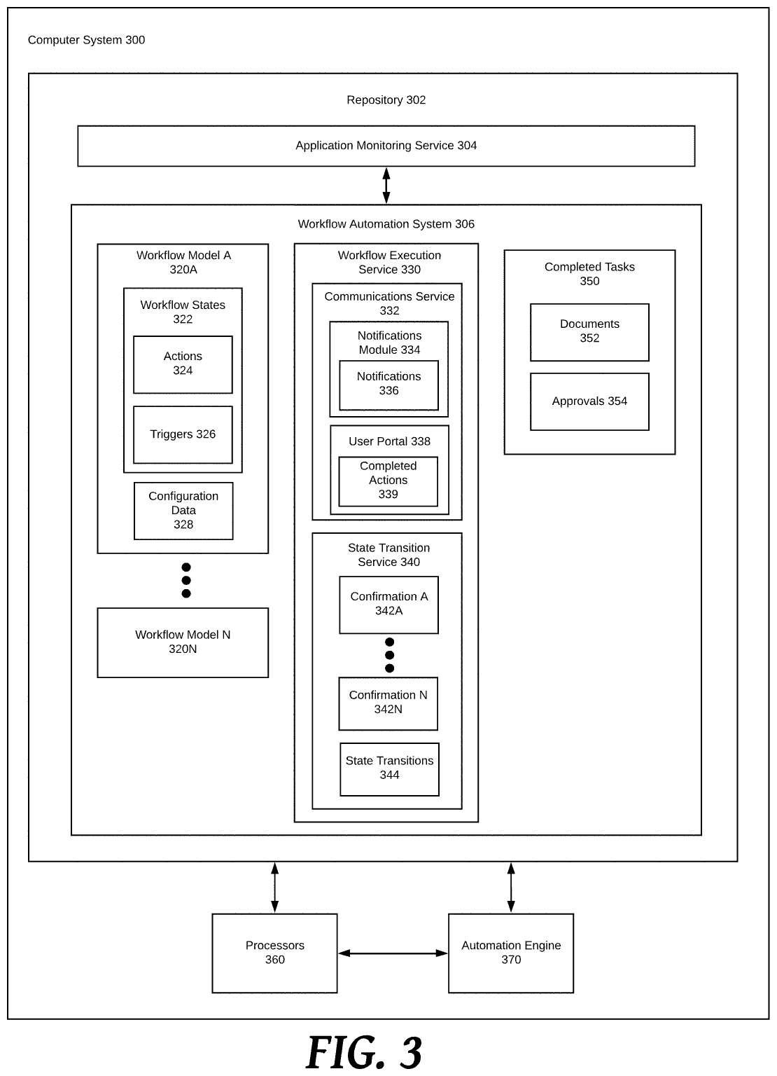

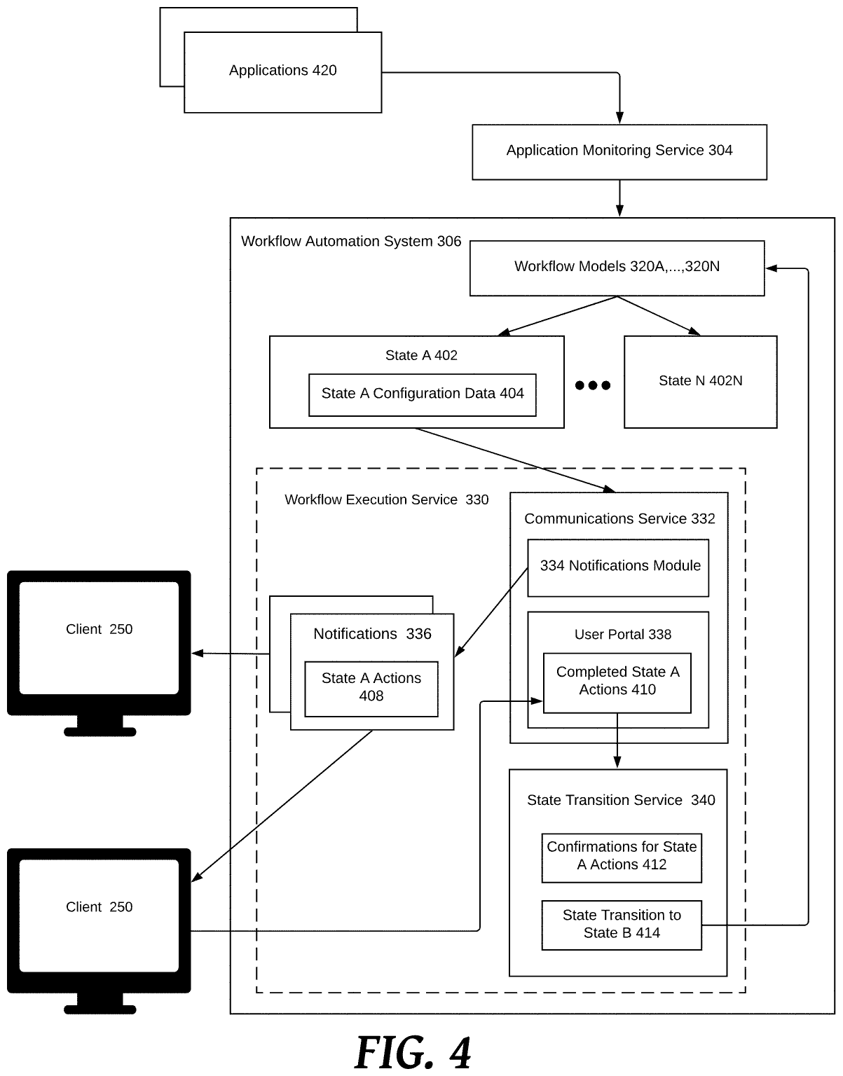

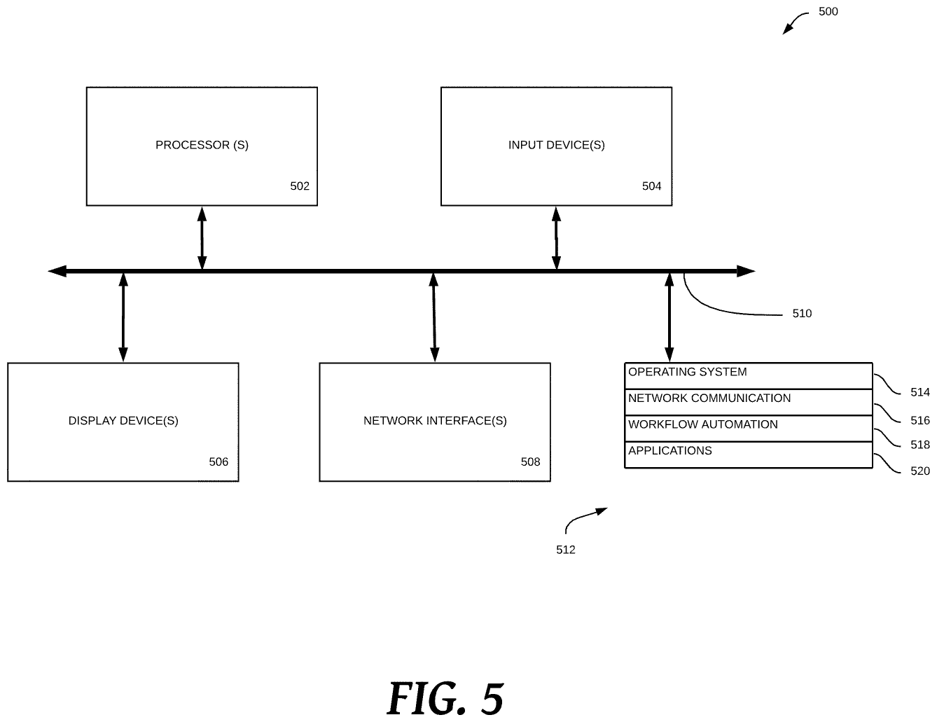

FIGS. 3-4 are block diagrams illustrating an example computer system 300 in accordance with one or more embodiments disclosed herein. As shown in FIG. 3, the computer system 300 includes a repository 302, an automation engine 370, and one or more computer processors 360. In one or more embodiments, the computer system 300 takes the form of the computing device 500 illustrated in FIG. 5 and the accompanying description below or takes the form of the client device 250 illustrated in FIG. 2. In one or more embodiments, the computer processor(s) 360 takes the form of the computer processor(s) 502 described in FIG. 5 and the accompanying description below.

In one or more embodiments, the repository 302 may be any type of storage unit and/or device (e.g., a file system, database, collection of tables, or any other storage mechanism) for storing data. Further, the repository 302 may include multiple different storage units and/or devices. The repository 302 may include an event bus 304 and a workflow automation system 306.

The event bus 304 interfaces with one or more in-product and or external applications. The in-product applications are integrated with the event bus 304 and or the workflow automation system 306. For example, the in-product applications may include an accounting application and the workflow automation system 306 integrated with the accounting application may be used to manage and execute accounting task workflows (e.g., invoice creation, invoice approval, general ledger entry creation, general ledger entry approval, and the like). The external applications are be integrated with the workflow automation system 306 but are connected to the event bus 304 or other integrations service. The external applications may include cloud databases, file management systems, and other data storage applications; customer relationship management applications; customer, e-commerce applications, billing applications, banking applications, accounting applications and other applications that track financial transactions; word processing applications and other document generating platforms; email applications, messaging platforms calendar applications, and other business communications applications; and the like.

The workflow automation system 306 include multiple workflow model templates 310. Each of the workflow model templates 310 may be specific to a particular type of task. For example, distinct workflow model templates 310 may exist for invoice creation and other document creation tasks, invoice approval and other hierarchical approval tasks, customer payment reminder and other reminder and notification tasks, and the like. The workflow model templates 310 include pre-determined states, actions, triggers, and conditions for each task. The workflow model templates 310 are pre-configured by the workflow automation system 306 to streamline implementation of the workflow model templates 310 as workflow models 320A, . . . , 320N for automating tasks.

The workflow models templates 310 may be customized by individual users to generate customized workflow models 320A, . . . , 320N that are tailored to fit an established internal process for completing a task. Each of the workflow models 320A, . . . , 320N provides an automated process for completing a business task (e.g., document creation, document approval, decision making, decision approval, and the like). The workflow models 320A, . . . , 320N include a plurality of workflow states 322 that include one or more actions 324 and triggers 326. The actions 324 are subtasks that are required to complete the task of the workflow model 320A so that each state breaks up the task into multiple subtasks that systematically progress the task from start to finish as the subtasks within each state are completed. For example, the actions 324 included in a workflow model for generating an invoice may include monitoring an external application to detect a sales event, extracting data associated with the new sales event (e.g., customer id, transaction amount, transaction date, customer contract information, and the like) from the external application, populating the extracted data into an invoice document, distributing the invoice document to one or more employees for review, receiving approval of the invoice, distributing the invoice to the customer, and booking the amount of the invoice as an accounts receivable entry.

The triggers 326 include particular events (i.e., completed actions and or tasks, started actions and or tasks, newly created data, updates to existing data, messages send, messages received, and the like) associated with the workflow states 322. Accordingly, the workflow state 322 of each of the workflow models 320A, . . . , 320N is determined by detecting one or more triggers 326 associated with the workflow state 322. For example, the event bus 304 may detect one or more triggers 326 in an activity that occurs within one or more of the in-product and or external applications monitored by the event bus 304. For example, the creation of a new and or updated business contact in a customer relationship management application may be detected as a trigger 326 that initializes a workflow model for creating a project estimate or bid document for a particular type of product or service. The sale of a product through an e-commerce application may be detected as a trigger 326 that initializes a workflow model for creating an invoice and or receipt.

Other triggers 326 may include the completion of one or more actions included in a workflow state 322. For example, state transition service 340 may receive a confirmation 342A for a particular action 324 included in the workflow model 320A executed by the workflow automation system 330. The confirmation 342A may be a trigger 326 that identifies the workflow state 322 including the particular action 324. Additionally, receiving confirmations 342A, . . . 342N for all actions 324 included in a workflow state 322 may be a trigger 326 for transitioning the workflow model 320A to a new workflow state 322. For example, receiving a confirmation 342A that an invoice document has been completed may be detected as a trigger 326 to transition the invoice creation workflow model from a document creation workflow state to a document approval workflow state. Receiving a confirmation 342A that an invoice has been approved may be detected as a trigger 326 that transitions the invoice creation workflow model from a document approval workflow state to a document delivery workflow state.

Each of the workflow models 320A, . . . , 320N includes conditions 329. The conditions 329 include one or more characteristics that must be present for the workflow automation system 306 to load a particular workflow model 320A. The conditions 329 may include one or more characteristics of an event or other trigger 326. For example, a condition 329 for the invoice approval workflow may require the invoice amount to be above a certain amount threshold in order to initiate the invoice approval workflow. The conditions 329 may be pre-configured by the workflow automation system based on one or more default rules associated with a particular workflow model template and or corresponding conditions in an in-product or external application. For example, a condition to require approval for invoices above $1,000 in an accounting application connected to the event bus 304 may be used to set up a condition on the invoice approval workflow to initiate the workflow only when the creation of an invoice of an amount that exceeds $1,000 is received by the event bus.

Each of the workflow models 320A, . . . , 320N includes configuration data 328. The configuration data 328 includes roles and permissions of users and or computer systems that interface with the workflow models 320A, . . . , 320N, notification settings, security settings, application integrations for interfacing with other applications, model parameters (e.g., size, type of task, language, location, and the like) and other data that facilitates management and or execution of the workflow models 320A, . . . , 320N. For example, the roles and permissions may include the users assigned to complete the manual actions (e.g., creating or editing documents, reviewing documents and or decisions, approving work completed by other users, drafting communications, and the like) of the workflow model and or the computer systems assigned to complete the automated actions (e.g., data extraction, template population, calculations, and the like) of the workflow model. The roles and permissions may also provide administrator privileges to certain users. Administrator privileges may include managing and or editing the workflow models 320A, . . . , 320N, changing the current workflow state of the workflow models 320A, . . . , 320N, tracking the workflow state of the workflow models 320A, . . . , 320N, viewing and or editing data (e.g., documents, approval records, communications, and the like) generated during a particular state of the workflow models 320A, . . . , 320N, and the like.

The roles and permissions may also include a particular approval hierarchy of the workflow model. The approval hierarchy may describe a particular sequence of approvals that must be completed in a particular order to complete the task of the workflow model. The approval hierarchy may assign particular approval roles to users and provide users assigned to higher positions within the hierarchy permissions to review and or change the approval actions completed by users assigned to lower positions in the hierarchy. To streamline configuration to the workflow models 320A, . . . , 320N, the positions of users within the approval hierarchy are determined automatically, For example, the positions of particular users within the approval hierarchy is automatically set-up based on the roles of the users in one or more in-product or remote applications. Notifications including approval tasks are automatically routed to users according to their roles and positions within the approval hierarchy. The email addresses and other contact information for sending the notifications are also automatically set-up based on the user profiles for the users identified in the approval hierarchy.

The notification settings include contact information for the users and or computer systems assigned to complete the actions 324 included in the workflow models 320A, . . . , 320N. For example, the contact information may include a username, employee id, account name, email address, telephone number, and the like for users associated with one or more actions 324 and a device id, device endpoint, IP address, MAC address, and the like for computer systems associated with one or more actions 324. The notification settings may also include other communications parameters such as the actions 324 to include in each notification generated during a particular workflow state and the frequency, type, and or timing of reminder notifications for incomplete actions 324. Notification settings for particular users and or computer systems are automatically configured by the workflow automation system 306. For example, the workflow automation system 306 extracts the contact information for the particular users and or computer systems from user profiles and system connection parameters included the in-product and or external applications that are connected to the workflow models 320A, . . . , 320N and or event bus 304.

The application integrations include API and or other instructions for accessing and interacting with in-product and or external applications. For example, the application integrations may connect the workflow models 320A, . . . , 320N to an in-product accounting application and or an external email application to detect triggers 326 of the workflow models 320A, . . . , 320N. The application integrations are also used to generate tasks for completing actions 324 within the in-product applications. The application integrations may also connect the workflow models 320A, . . . , 320N to a counter party portal or other application that delivers documents, messages, and other data generated during execution of the workflow models 320A, . . . , 320N to one or more third parties. The application integrations may also connect the workflow models 320A, . . . , 320N to a user portal 338 or other application that receives inputs thereto from users to complete actions 324.

The application integrations also connect the workflow automation system 306 to an audit and or reporting application. The audit application calculates performance metrics to evaluate the benefits and or drawbacks of automating business tasks using the workflow models 320A, . . . , 320N. For example, the performance metrics may include the time required to complete particular actions and or workflow states 322, the total time required to complete all actions 324 and or workflow states 322 included in a workflow model 320A, the number of reminder notifications required to complete actions 324 and or workflow states 322, the actions 324 that most frequently required one or more reminder notifications, the most frequently performed actions 324, workflow states 322, and or workflow models 320A, . . . , 320N, and or the maximum, minimum, average, and other statistical calculation based on the number of events and or time required to complete actions 326, workflow states 322, and or workflow models 320A, . . . , 320N. The performance metrics may also include the efficiency achieved or lost (i.e., a net time increase or decrease) of performing a particular task using the workflow models 320A, . . . , 320N relative to performing the particular task using manual methods and or other automation tools. The performance metrics may also determine the system performance of the server device and or other computer system 300 while loading, persisting, and or executing operations of the workflow automation system 306. For example, performance metrics may include the amount of memory allocated to the workflow automation system 306 and or workflow models 320A, . . . , 320N, the processing resources required to execute each workflow model 320A and or a baseline number (e.g., 100, 1000, 10,000 and the like) of instances of the one or more workflow models simultaneously, the amount of storage required to persist the workflow models 320A, . . . , 320N and or workflow automation system 306, the cost required to maintain the computer system 300 running the workflow automation system 306, and the like. The performance metrics may be calculated for an individual workflow model 320A and or a group of workflow models 320A, . . . , 320N having any size and or composition (e.g., a group of six invoice generation workflow model instances and seven invoice approval workflow model instances).

The reporting application aggregates and organizes the performance metrics calculated by the audit application to generate one or more reports. The reports may be organized by type of workflow model 320A, business unit(s) responsible for performing the tasks of the workflow models 320A, . . . , 320N, period of time, machine instance running a particular implementation of the workflow automation system, and the like. To facilitate generating the reports, the application integrations may connect the reporting application to one or more word processing, chart drawing, other graphics and or document generation applications. The performance metrics calculated by the audit application and or the reports generated by the reporting application are provided to one or more users and or computer systems having auditing and or reporting permissions in the roles and permissions of the configuration data 328. The reports and or performance metrics are used to modify one or more aspects of the workflow automation system 306 to improve the performance of the workflow automation system 306 and or the efficiency of tasks completed using the workflow models 320A, . . . , 320N relative to manual methods and other automation tools.

The workflow models 320A, . . . , 320N are executed by a workflow execution service 330. The workflow execution service 330 loads a particular workflow model 320A based on the detection of one or more of the workflow model's triggers 326. For example, the workflow execution service 330 may load a workflow model 320A in response to an event in an in-product or external application detected by the event bus 304. Other triggers 326 may also be detected by the event bus 304 and or the workflow automation system 306 to cause the workflow execution service 330 to load one or more of the workflow models 320A, . . . , 320N.

The workflow execution service 330 includes a communications service 332 and a state transition service 340 that perform the operations required to complete the tasks automated by the workflow models 320A, . . . , 320N. To execute a workflow model 320A, the workflow execution service 330 loads the workflow model 320A and or determines the current state of a pre-loaded workflow model 320A based on the detection of one or more triggers 326 associated with the workflow model 320A and or a particular workflow state 322. The communications service 332 includes a notifications model 334 that generates one or more notifications 336 to complete actions 324. The notifications 336 are distributed by the notifications model 334 to one or more users and or computer systems. The users and or computer systems receiving notifications 336 for each of the actions 324 (i.e., the users and computer systems responsible for completing the actions 324 in the notifications 336) are retrieved from the configuration data 328 for the workflow model 320A. The notifications model 334 also distribute the notifications 336 to the users and or computer systems using contact information included in the configuration data 328.

The notifications 336 include a description of the actions 324 that need to be completed by each user and or computer system receiving the notification 336, a prompt to complete the described action 324, and or a link to a user portal 338. The user portal 338 includes one or more user interface (UI components) that may display graphics and data associated with the described actions 324 and or link to one or more in-product or external applications needed to complete the actions 324. The user portal 338 may also include UI components that receive inputs thereto that are used to complete the actions 324. Actions 324 completed by users and computer systems may be received in the user portal 338 as completed actions 339. For example, the user portal 338 may be used to review and approve a completed project estimate generated by one or more workflow states 322 of an estimate generation workflow model. The user portal 338 may also be used to approve an invoice during one or more workflow states 322 of an invoice approval workflow model.

To increase employee productivity and facilitate adoption of workflows for automating tasks, actions 324 are completed within one or more in-product applications integrated with the workflow automation system 306. The notifications module 334 sends notifications 336 to users within the in-product application. Users open the notifications 336 and complete the actions 324 included in the notifications within the in-product application. For example, the actions for a workflow model for an invoice approval task may be completed within an accounting application integrated with the workflow automation system 306. The notifications module 334 may send notifications 336 to users within the accounting application. The notifications 336 may include a link to the portion of the accounting application that displays the invoice data (i.e., an invoice review user interface (UI)). The invoice approval model may generate an “approve invoice” button or other UI element for inputting an approval decision in response to the user navigating to the invoice review UI. The user may then select the “approve invoice” button to complete the invoice approval action. The workflow execution service 330 may transition the workflow model to a new workflow state based on the selection of the “approve invoice” button or receiving another input in the invoice review UI. Accordingly, the workflow automation system 306 may integrate task automation workflows into tools currently used to complete tasks manually. By making automation workflows compatible with existing tools, the workflow automation system 306 reduces the friction (e.g., employee frustration, training time, and the like) associated with transitioning tasks from manual workflows to automated workflows.

The state transition service 340 reviews the completed actions 339 received by the user portal 338 and the in-product application to confirm if each completed action 339 satisfactorily completes the subtasks included in its corresponding action 324. The state transition service 340 detects and or generates confirmations 342A, . . . , 342N for each completed action 339 that satisfactory completes one of the actions 324. If confirmations 342A, . . . , 342N for all of the actions 324 included in a workflow state 322 are detected by the state transition service 340, the state transition service 340 performs a state transition 344 to progress the workflow model 320A from the current workflow state to a new workflow state. If a confirmation 342A is not detected for one or more actions 324, the notifications module 334 generates a reminder for each unconfirmed action and distribute the reminders to the users and or computer systems assigned to complete the unconfirmed actions.

In response to the state transition 344 to a new workflow state, the notification module 334 generates and distributes notifications 336 for the actions 324 included in the new workflow state. The state transition service 340 confirms that the actions 324 were completed and performs a state transition 344 to the next new workflow state included in the workflow model 320A. This process repeats until all workflow states 322 in the workflow model 320A are completed. When all workflow states 322 in a workflow model 320A are completed, the workflow execution service 330 generates a completed task 350. For example, completed tasks 350 generated by the workflow execution service 330 may include documents 350 (e.g., estimates, invoices, reports, and the like generated by a workflow model) and or approvals 354 (e.g., approvals of invoices, estimates, reports, bookkeeping entries, purchase decisions, lending decisions, promotions, and other documents and or decisions).

FIG. 4 illustrates more details of the workflow automation system shown in FIG. 3. The workflow automation system 306 initiates execution of workflow models 320A, . . . , 320N in response to detecting one or more triggers included in the workflow models 320A, . . . , 320N. The triggers may include the occurrence of one or more events in one or more applications 420. The triggers in the applications 420 are detected by an event bus 304. The workflow models 320A, . . . , 320N include a plurality of states 402A, . . . , 402N. Each of the states 402A, . . . , 402N has multiple actions and triggers. The triggers initiate the states 402A, . . . , 402N and the actions include subtasks to be completed during the states 402A, . . . , 402N to complete the overall task of the workflow model 320A. The states 402A, . . . , 402N also include configuration data (e.g., roles and permissions, notifications settings, security settings, application integrations, and the like) to facilitate execution of the states 402A, . . . , 402N by the workflow execution service 330.

To execute a workflow model 320A, the workflow execution service 330 loads the workflow model 320A in response to detection of a trigger of state A 402. The communications service 332 receives state A 402 of the workflow model 320A. The notification module 334 generates notifications including the actions included in state A (i.e., the state A actions 408). The notifications 336 are generated and or distributed to one or more clients 250 according to the notifications settings and roles and permissions included in the state A configuration data 404. To complete the state A actions 408, users and or computer systems assigned to each action access the state A actions through the client 250. For example, the users and or computer systems may access an instance of the user portal 338 and or in-product application running on the client(s) 250. The users and or computer systems may use the client(s) 250 to complete the state A actions 408. Completed state A actions 410 are received by the communications service 332 in the user portal 338 and or the in-product application.

The state transition service 340 reviews the completed state A actions 410 to detect and or receive confirmations for state A actions 412. If confirmations for all state A actions 408 are received and or detected by the state transition service 340, the state transition service 340 executes a state transition to state B 414. The state transition to state B 414 dispatches state B or another new state of the workflow model to the workflow execution service 330 and the workflow execution service 330 executes state B. This process is repeated until all of the states 402A, . . . , 402N of the workflow model are complete. If all of the states 402A, . . . , 402N of the workflow model are complete, the workflow automation service 306 terminates the workflow model and waits for the detection of a new trigger to initiate execution of new workflow model instance.

FIG. 5 shows an example computing device according to an embodiment of the present disclosure. For example, computing device 500 may function as client device 250, first server 220, and or second server 230. The computing device 500 may include a machine translation system that executes the integrated machine translation process described above or a portion or combination thereof in some embodiments. The computing device 500 may be implemented on any electronic device that runs software applications derived from compiled instructions, including without limitation personal computers, servers, smart phones, media players, electronic tablets, game consoles, email devices, etc. In some implementations, the computing device 500 may include one or more processors 502, one or more input devices 504, one or more display devices 506, one or more network interfaces 508, and one or more computer-readable mediums 512. Each of these components may be coupled by bus 510, and in some embodiments, these components may be distributed among multiple physical locations and coupled by a network.

Display device 506 may be any known display technology, including but not limited to display devices using Liquid Crystal Display (LCD) or Light Emitting Diode (LED) technology. Processor(s) 502 may use any known processor technology, including but not limited to graphics processors and multi-core processors. Input device 504 may be any known input device technology, including but not limited to a keyboard (including a virtual keyboard), mouse, track ball, camera, and touch-sensitive pad or display. Bus 510 may be any known internal or external bus technology, including but not limited to ISA, EISA, PCI, PCI Express, USB, Serial ATA or FireWire. Computer-readable medium 512 may be any non-transitory medium that participates in providing instructions to processor(s) 504 for execution, including without limitation, non-volatile storage media (e.g., optical disks, magnetic disks, flash drives, etc.), or volatile media (e.g., SDRAM, ROM, etc.).

Computer-readable medium 512 may include various instructions 514 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 504; sending output to display device 506; keeping track of files and directories on computer-readable medium 512; controlling peripheral devices (e.g., disk drives, printers, etc.) which can be controlled directly or through an I/O controller; and managing traffic on bus 510. Network communications instructions 516 may establish and maintain network connections (e.g., software for implementing communication protocols, such as TCP/IP, HTTP, Ethernet, telephony, etc.).

Workflow automation instructions 518 may include instructions that enable computing device 500 to function as a workflow automation system and/or to provide workflow automation system functionality as described herein. Application(s) 520 may be an application that uses or implements the processes described herein and/or other processes. The processes may also be implemented in operating system 514. For example, application 520 and/or operating system 514 may present UIs 252 for generating reviewing and or completing workflow actions.

The workflow automation approach described herein provides a simplified framework for digitally managing and executing business processes. In comparison to manual methods, the workflow automation approach increases the speed and reduces the number of manhours required to generate documents, approve documents, and complete other business tasks. The workflow automation approach may eliminate time consuming manual data entry tasks by connecting to existing applications to pull data into the workflow from other sources. The workflow automation approach may also send digital reminders and automatically generate and assign tasks to employees having the required permissions. This may reduce reliance on manual reminders, which may take several minutes to deliver, and eliminate human errors (e.g., getting distracted, forgetting, not being aware of particular responsibilities, and the like).

The workflow automation approach is also easier to set up and manage compared to existing workflow automation tools. For example, the workflow automation approach may be used to instantaneously implement pre-configured workflows, which eliminates several weeks of set up time to digitally implement a manual business process using other solutions. The simplified framework and automatic configurations of the disclosed approach reduce the amount of time required to create, update, and configure task workflows by reducing the complexity of existing automation tools. The approach's simplified framework also improves the computational efficiency of digitally managing and executing tasks relative to other platforms. For example, the task workflow automation approach eliminates many of the set up and configuration steps required by other solutions to decrease the UI screens, set up commands, and computations that are required to digitally manage and execute a particular workflow. Eliminating these steps reduces the amount of processing resources, memory allocation, storage capacity, system runtime hours, and electrical power required to digitally create, manage, and execute a workflow relative to existing automation platforms.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computer implemented method of automating task workflows for integrating the workflows between a plurality of different applications to improve computational efficiency of managing and executing tasks, the method comprising:
receiving a workflow model including configuration data and multiple states, the configuration data extracted from a plurality of different applications connected to the workflow model, each of the multiple states being associated with multiple triggers and including multiple actions, and the plurality of different applications comprising one or more in-product applications and one or more remote applications;
automatically detecting at least one of the multiple triggers of at least one of the multiple states of the workflow model based on a plurality of activities that occur in at least a subset of the plurality of different applications;
determining a particular state of the workflow model based on the at least one detected trigger;
distributing a notification according to a set of roles and permissions included in the configuration data, the notification including at least one action from the multiple actions;
receiving a confirmation that the at least one action included in the notification is complete; and
transitioning the workflow model to a new state based on the confirmation.

2. The method of claim 1, wherein the roles and permissions identify one or more users that are responsible for completing the multiple actions included in each workflow state, the method further comprising:
configuring the roles and permissions based on a related set of roles and permissions for the one or more users in the application.

3. The method of claim 1, wherein the configuration data includes a set of application integrations, the method further comprising:
connecting the workflow model to an audit application based on the set of application integrations.

4. The method of claim 3, further comprising:
calculating a performance metric for the workflow model that describes a measure of efficiency of performing a task using the workflow model relative to performing the task using an alternate method; and
distributing a report to one or more users through the audit application based on the roles and permissions, the report including the performance metric.

5. The method of claim 1, further comprising:
confirming that the multiple actions in each of the multiple states of the workflow model are complete;
receiving an output generated by the completed multiple actions; and
using the output to complete a business task.

6. The method of claim 1, further comprising:
determining that at least one of the multiple actions of the multiple states of the workflow model is not confirmed as complete;
sending a reminder notification including the incomplete action to a user responsible for completing the incomplete action; and
receiving a confirmation from the user that the incomplete action is completed.

7. The method of claim 1, wherein the workflow model is a document workflow model and the multiple actions included in the multiple states of the document workflow model include subtasks for completing a document.

8. The method of claim 1, wherein the workflow model is an approval workflow model and the multiple actions included in the multiple states of the approval workflow model include subtasks for approving a decision or completed document.

9. The method of claim 1, further comprising distributing the notification to at least one user to complete a manual task included in the at least one action included in the notification or a computer system to complete an automated task included in the at least one action included in the notification.

10. The method of claim 1, wherein the application includes a user interface (UI) that displays data and receives multiple inputs; and wherein the notification includes a link to a portion of the user interface that is used to complete the at least one action; the method further comprising;
receiving an input in the UI that completes the at least one action; and
transitioning the workflow model to a new state based on the input.

11. A system for automating task workflows for integrating the workflows between a plurality of different applications to improve computational efficiency of managing and executing tasks, said system comprising:
a repository configured to store a workflow model including multiple states and configuration data, the configuration data extracted from a plurality of different applications connected to the workflow model via a network interface, wherein the plurality of different applications comprise one or more in-product applications and one or more remote applications; and
a workflow automation system, executing on a processor and being configured to:
receive the workflow model from the repository coupled to the workflow automation system via the network interface, each of the multiple states included in the workflow model being associated with multiple triggers and including multiple actions;
automatically detect at least one of the multiple triggers of at least one of the multiple states of the workflow model based on a plurality of activities that occur in at least a subset of the plurality of different applications;
determine a particular state of the workflow model based on the at least one detected trigger;
distribute a notification according to a set of roles and permissions included in the configuration data, the notification including at least one action from the multiple actions;
receive a confirmation that the at least one action included in the notification is complete; and
transition the workflow model to a new state based on the confirmation.

12. The system of claim 11, wherein the roles and permissions identify one or more users that are responsible for completing the multiple actions included in each workflow state, the workflow automation system further configured to:
pre-configure the roles and permissions based on a related set of roles and permissions for the one or more users in an application.

13. The system of claim 11, wherein the configuration data includes a set of application integrations; the workflow automation system further configured to:
connect the workflow model to an audit application via the network interface based on the set of application integrations.

14. The system of claim 13, wherein the workflow automation system is further configured to:
calculate a performance metric for the workflow model that describes a measure of efficiency of performing a task using the workflow model relative to performing the task using an alternate method; and
distribute a report to one or more users through the audit application based on the roles and permissions, the report including the performance metric.

15. The system of claim 11, wherein the workflow automation system is further configured to:
confirm that the multiple actions in each of the multiple states of the workflow model are complete;
receive an output generated by the completed multiple actions; and
use the output to complete a business task.

16. The system of claim 11, wherein the workflow automation system is further configured to:
determine that at least one of the multiple actions of the multiple states of the workflow model is not confirmed as complete;
send a reminder notification including the incomplete action to a user responsible for completing the incomplete action; and
receive a confirmation from the user that the incomplete action is completed.

17. The system of claim 11, wherein the workflow model is a document workflow model and the multiple actions included in the multiple states of the document workflow model include subtasks for completing a document.

18. The system of claim 11, wherein the workflow model is an approval workflow model and the multiple actions included in the multiple states of the approval workflow model include subtasks for approving a decision or completed document.

19. The system of claim 11, wherein the workflow automation system is further configured to distribute the notification to at least one of a user to complete a manual task included in the at least one action included in the notification or a computer system to complete an automated task included in the at least one action included in the notification.

20. The system of claim 11, wherein the application includes a user interface (UI) that displays data and receives multiple inputs; and the notification includes a link to a portion of the user interface that is used to complete the at least one action;
and wherein the workflow automation system is further configured to receive an input in the UI that completes the at least one action; and
transition the workflow model to a new state based on the input.
